(19) United States
(12) Patent Application Publication
(10) Pub. No.: US 2010/0200033 A1
(43) Pub. Date: Aug. 12, 2010

(54) Shade wing

(76) Inventor: Walter Forester, Springfield, MO (US)

Correspondence Address: Walter L. Forester, P.O. Box 11245, Springfield, MO, 65808, US

(21) Appl. No.: 12/657,899

(22) Filed: Jan. 29, 2010

Related U.S. Application Data
(60) Provisional application No. 61/151,050, filed on Feb. 9, 2009.

(51) Int. Cl. E04H 15/06; F16B 9/00

(52) U.S. Cl. 135/88.04; 403/167

(57) ABSTRACT

A rectangular wing formed by two parallel fiberglass ribs, tubular leading edge and tubular trailing edge with a nylon cover. The attack angle of the leading edge is controlled by the rider of the bicycle or tricycle giving lift to the wing. This lift assists in the support of the wing allowing for lighter wing ribs to be used in the construction. The lighter construction and reduced wind resistence increases the efficiency of the bicycle or tricycle using less human effort for propulsion while providing protection from sun and light rain.

### CROSS-REFERENCE TO RELATED APPLICATIONS

Provisional Application No. 61/151,050

I claim the benefit of the first filing date Feb. 9, 2009

Filed: Feb. 9, 2009

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### RELATED APPLICATION

The present U.S. Non-provisional Patent Application is based upon U.S. Provisional Patent Application No. 61/151,050 filed Feb. 9, 2009, the subject matter of which is incorporated herein by reference.

### BACKGROUND OF THE INVENTION

(1) Field of the Invention

The present invention relates to an aerodynamic wing protecting a rider of a bicycle or tricycle from sun and light rain, without appreciably increasing weight or drag (wind resistence).

(2) Description of Prior Art

Many designs and configurations exist in the prior art. The use of fixed supports to maintain a cover over a rider is most common. The use of flexible supports such as fiberglass or wood rods as is found in most tent applications is less common when related to supporting a cover over the rider of a bicycle or tricycle.

By way of example U.S. Patent Application Publication Number US 2009/0090405A1 Publication Date Apr. 9, 2009 Relates to an arched canopy system for installation on recumbent bicycles.

While forming an excellent cover for the rider it is at the expense of weight and drag (wind resistence) much decreasing the efficiency of the vehicle. In this particular design the drogue effect of trapping the wind much decreases the forward momentum of the vehicle.

The present invention is an aerodynamic wing which creates lift and assists the support of the cover and ribs. This allows for lighter construction which equates to more efficient propulsion by the rider of the bicycle or tricycle. This clearly departs from all previously known designs related to giving protection from sun and light rain to a rider of a bicycle or tricycle.

### SUMMARY OF THE INVENTION

The present invention diverges from the previous art by providing the rider of the bicycle or tricycle a more easily propelled (lighter with less drag), protection from sun and light rain.

To attain less drag the present invention is a wing over the rider providing lift which assists in the support of the fiberglass wing ribs, while the bicycle or tricycle is in motion.

The present invention comprises a rectangular wing frame composed of two lateral fiberglass rods forming the ribs of the wing. Forming the leading and trailing edges of the wing are two CPVC tubes. These CPVC tubes are drilled, as illustrated in detailed descriptions, to receive the fiberglass ribs of the wing frame.

The wing frame cover is a rectangular nylon cloth with pockets sewn adjacent to all four sides. These pockets receive the fiberglass ribs, CPVC leading edge of the wing and the CPVC trailing edge of the wing.

Control cables attach the leading edge of the wing to any convenient location on the front of the bicycle or tricycle. Due to differing designs this may or may not be a handlebar. The trailing edge is connected by two steel coupling tubes to extension rods which form part of the Universal Adapter allowing the wing to be attached to any bicycle or tricycle.

Provided last is the Universal Adapter which allows the wing to be attached to any bicycle or tricycle. This device has six parts. Four of the parts are used to attach the wing to a bicycle seatpost. All six parts are used to attach the wing to a basket or crosstube. Examples of these applications are found in the detailed description section.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited to its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for designing other structures, methods and systems for carrying out the several purposes or the present invention. It is important, therefore, that claims be regarded as including such equivalent constructions in so far as they do not depart from the spirit and scope of the present invention.

It is the object of the present invention to improve the prior art of known designs and configurations.

It is the object of this invention to provide protection from sun and light rain to the rider of a bicycle or tricycle, creating the least amount of weight and wind resistance possible.

It is the object of the present invention to decrease manufacturing costs so as to enhance marketability. This is made possible by using ultralight aircraft technology and design, in the construction of the invention.

It is the object of the present invention to have the ability to be attached to any bicycle or tricycle. This is accomplished by using the Universal Adapter as described in detailed descriptions and drawings.

Lastly, it is the object of this present invention to provide a rectangular wing frame composed of a tubular leading edge and a tubular trailing edge and two fiberglass lateral ribs. These parts are inserted in the sewn pockets of the rectangular nylon cover. The rear of the wing is attached to the vehicle by two steel coupling tubes and two round metal rods with eyes which are then secured by two bolts to the Universal Adapter which is described further in the detail and descriptions section. The Universal Adapter will attach to any bicycle or tricycle. The leading edge of the wing attaches to the front of the vehicle using two friction slide lock control cables which attach to the leading edge fiberglass ribs using nylon friction tubing. These cables are attached to the vehicle using two Velcro straps.

These together with other objects of the invention, along with the various features of novelty which characterize the invention, are pointed out with particularity in the claims annexed to and forming a part of this disclosure. For a better understanding of the invention, its operating advantages and the specific objects attained by its uses, references should be had to the accompanying drawings and descriptive matter in which there is illustrated preferred embodiments of the invention.

### BRIEF DESCRIPTION OF DRAWINGS

The invention will be better understood and the objects other then those set forth above will become apparent when consideration is given to the following detailed descriptions thereof. Such description makes reference to the annexed drawings wherein:

FIG. 1A is a plan view of the wing frame.

FIG. 1B is an enlarged plan view of the relationship between the leading and trailing edge CPVC tubes and the fiberglass wing ribs after the wing ribs are inserted into the offset holes. This offset spreads the fiberglass wing ribs giving rigidity to the wing cover, thus eliminating the need for a center CPVC wing support.

FIG. 1C is an enlarged plan view of the dimpled steel tube that couples the two fiberglass wing ribs.

FIG. 2 is a plan view of the nylon cover installed on the wing frame.

FIG. 3A is a perspective view of the wing control cables installed on handlebars.

FIG. 3B is a perspective view of the Velcro strapping attaching the control cables to a handlebar type application.

FIG. 4A is a perspective view of the angle plate which is one of the three parts of the Universal Adapter. The two angle plates 20 and the two extension rods 20b are used to form the Universal Adapter bicycle seatpost application (FIGS. 5A and 5B).

FIG. 4B is the plan view of the backplate. The two backplates 20a are used in combination with two angleplates 20 (FIG. 4A) and two extension rods 20b (FIG. 4C). These form the Universal Adapter basket application (FIGS. 6A and 6B). The two backplates 20a are also used in combination with two angleplates 20 (FIG. 4A and FIG. 4B) to form the Universal Adapter crosstube application (FIG. 7A and FIG. 7B).

FIG. 4C is a plan view of the extension rod which is one of the three parts of the Universal Adapter. It is used on all Universal Adapter applications to attach the trailing wing ribs using two coupling tubes 12b.

FIG. 5A is a perspective view of a bicycle with a shade wing attached.

FIG. 5B is an enlarged exploded perspective view showing the seatpost application of the Universal Adapter.

FIG. 6A is a perspective view of an adult tricycle with a shade wing attached (basket application).

FIG. 6B is an enlarged exploded perspective view showing the basket application of the Universal Adapter.

FIG. 7A is a perspective view of an adult tricycle with a shade wing attached (crosstube application).

FIG. 7B is an enlarged exploded perspective view showing the crosstube application of the Universal Adapter.

FIG. 8 Shows the lift created by the camber 26 of the wing.

### DETAILED DESCRIPTION OF THE INVENTION

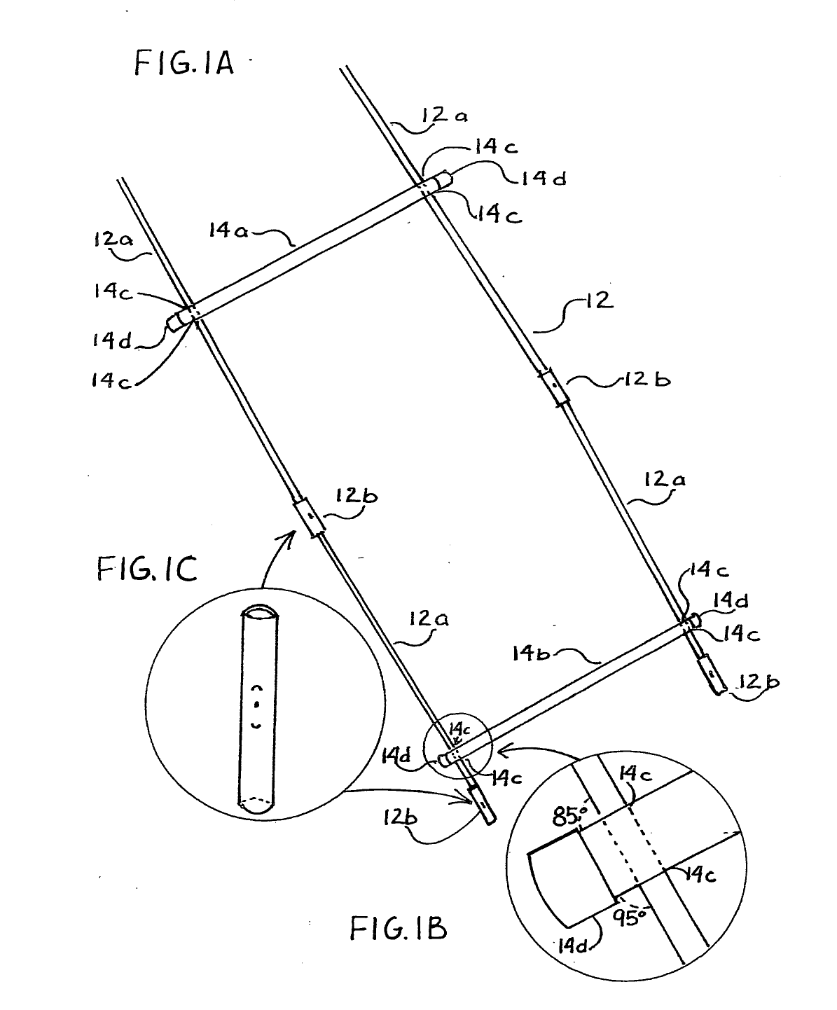

With reference now to the drawings and in particular to FIG. 1A thereof, the preferred embodiment of the shade wing embodying the principles and concepts of the present invention and generally designated by the reference numeral 10 will be described.

The present invention, the shade wing 10 is comprised of a plurality of components. Such components in their broadest context include a frame, leading edge shade wing frame control cables, a wing cover and a device for attaching the shade wing frame to any bicycle or tricycle. Such components are individually configured and correlated with respect to each other so as to attain the desired objective.

First provided is a bicycle 22. The bicycle has handlebars 22a. The bicycle has a seat post 22b.

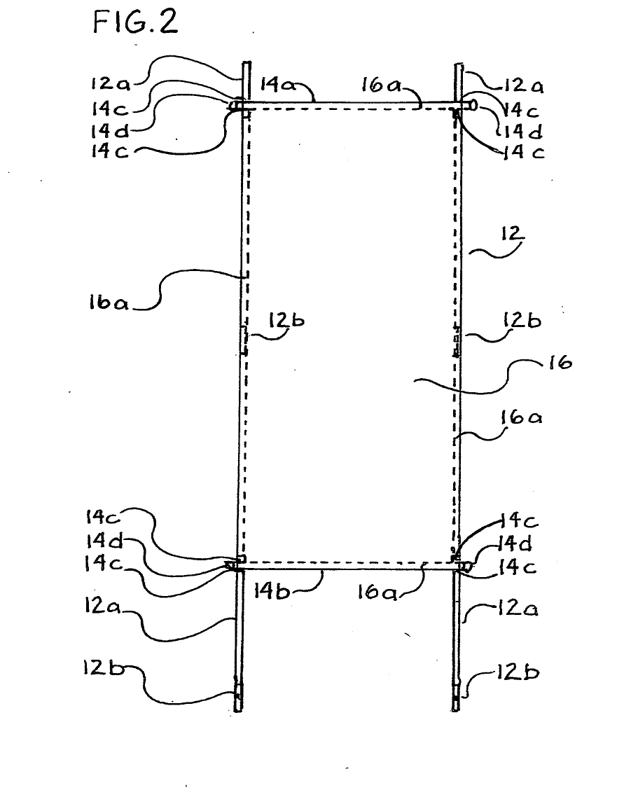

The shade wing begins with a frame FIG. 1A and a frame cover FIG. 2 Ref. No. 16. The frame is constructed as follows: four ¼ inch outside diameter by 30 inches in length fiberglass wing ribs 12a coupled by two ¼ inch by 2 inches in length steel connecting tubes dimpled in the center FIG. 1C to limit their travel on the fiberglass ribs and steel rods.

A nylon cover 18½ inches in width by 40 inches in length Ref. No. 16 with ½ inch pockets sewn on all four sides is provided as a cover for the wing frame FIG. 2 Ref. No. 16a. The fiberglass ribs, 60 inches in length now coupled Ref. No. 12a and Ref. No. 12b are inserted into the two side pockets of the wing cover see FIG. 2 Ref. No. 16a. The leading edge wing tube (½ inch inside diameter CPVC, 19½ inches in length) Ref. No. 14a and the trailing edge wing tube (½ inch inside diameter CPVD, 19½ inches in length) Ref. No. 14b are then inserted into the front and rear pockets of the wing cover FIG. 2. Holes (¼ inch) Ref. No. 14b are drilled ½ inch from either end of the leading edge and the trailing edge tubes FIG. 2 Ref. No. 14c. An important feature is that these holes, Ref. No. 14c are drilled at a 5 degree angle. The wing ribs Ref. No. 12a are now inserted into the holes provided in the leading edge and trailing edge tubes Ref. No. 14c. The fiberglass wing ribs then have an outward deflection stretching the wing cover increasing rigidity and eliminating the need for center wing cross-bracing FIG. 1B. Four ⅝ inch poly endcaps Ref. No. 14d are now installed on each of the four ends of the leading and trailing edge CPVC wing tubes.

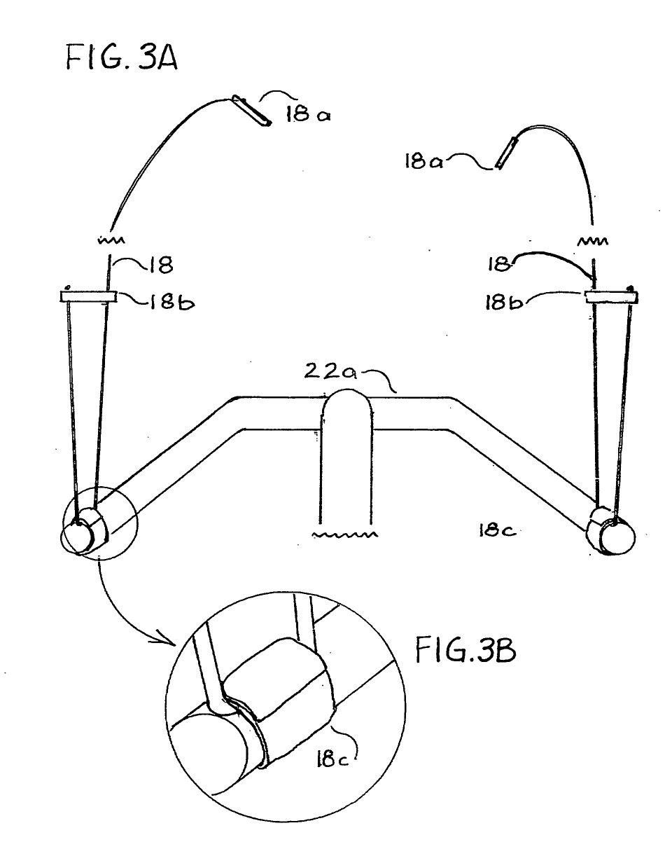

Leading edge wing tube control cables 36 inches in length are now provided FIG. 3. The control cables are braided nylon Ref. No. 18. Two nylon tubing ¼ inch inside diameter with ⅛ inch holes drilled (¼ inch from each end) slide-locks Ref. No. 18b are provided. Two nylon wing frame connection tubes (¼ inch inside diameter, holes drilled ¼ inch from each end) connecting the control cables to the leading edge wing frame are provided FIG. 3A. Two Velcro straps (8 inches in length) FIG. 3B Ref. No 18c attaching the control cables to a handlebar or any convenient location on alternate applications is provided.

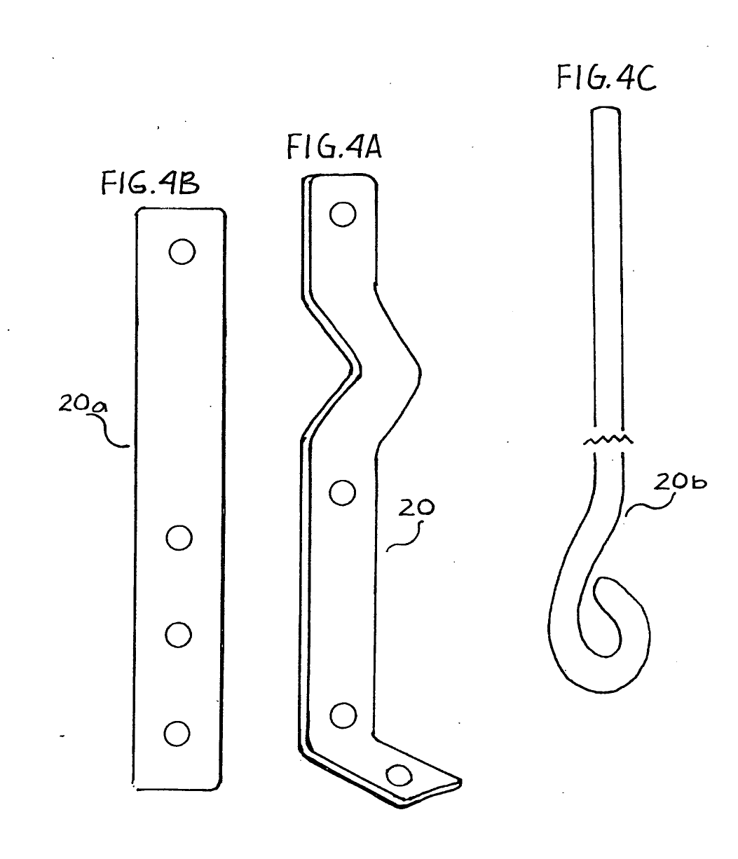

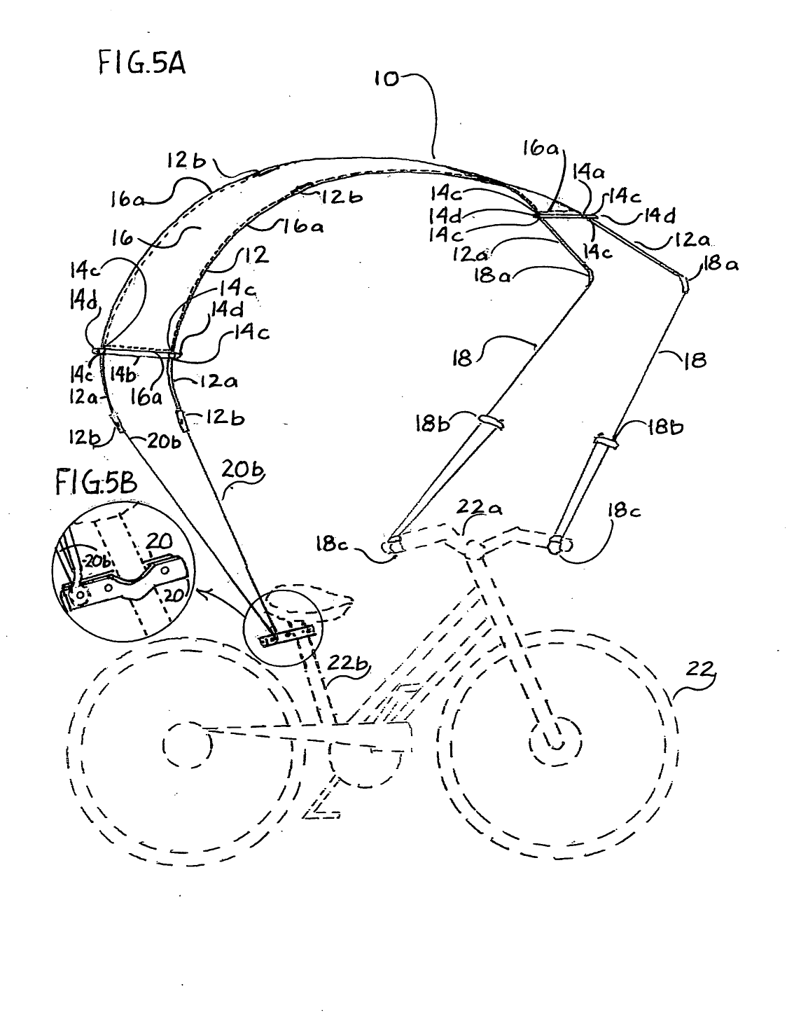

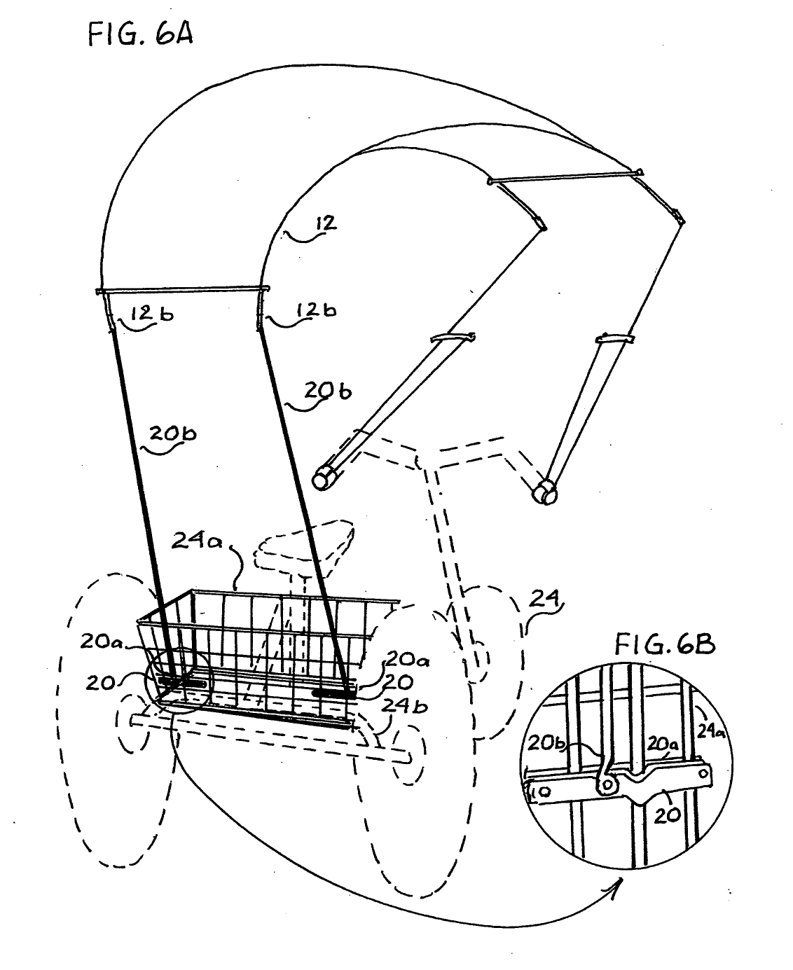

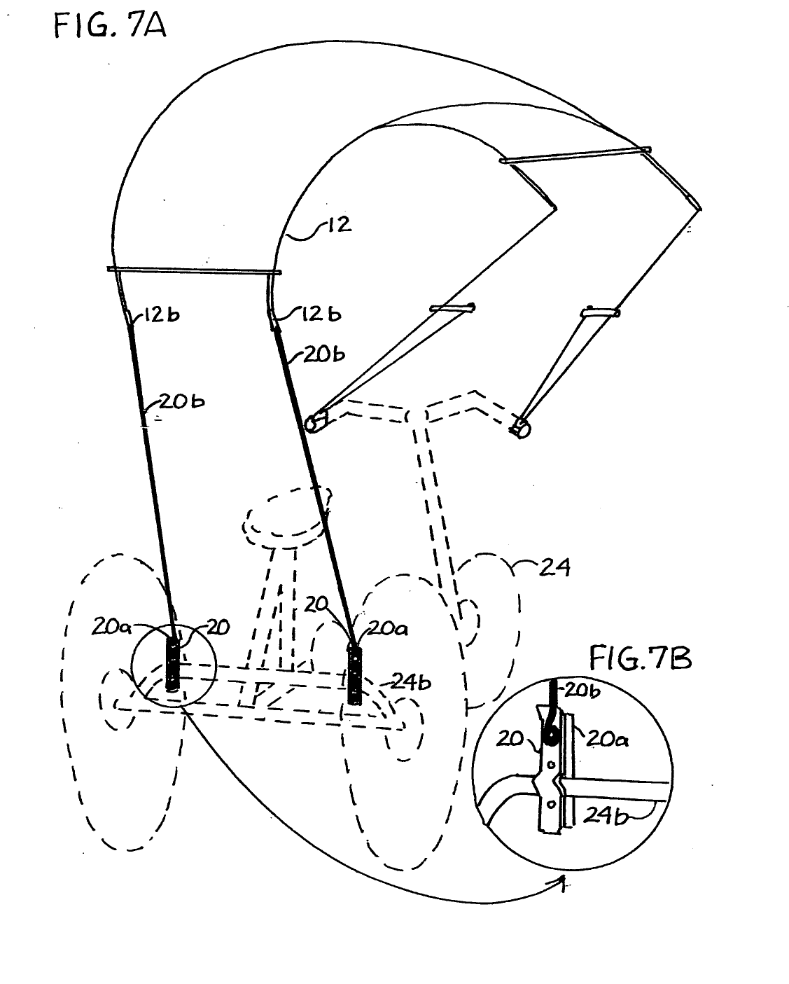

The Universal Adapter is now installed FIG. 4A, FIG. 4B, FIG. 4C. Bicycles and tricycles have three basic possible installations: seat post FIG. 5B, basket FIG. 6B and crosstube FIG. 7B. The Universal Adapter is manufactured as follows: two ⅛^{th} inch steel strap material pressed and bored FIG. 4A, two 18 gauge malleable steel straps (¾ inches wide by 6½ inches in length) pressed and bored FIG. 20A, and two ¼ inch round steel rods 20 inches in length with ¼ inch eye fabricated on one end of each FIG. 4C.

In each of the above cases, after the Universal Adapter is bolted in place, the fiberglass wing ribs are fitted with a steel coupling tube Ref. No. 12b and are then inserted on the Universal Adapter steel rods Ref. No. 20b. At this time, the control cables (36 inches in length) Ref. No. 18 are attached to the handlebar Ref. No. 22a and FIG. 3B or convenient location on the bicycle or tricycle, completing the installation.

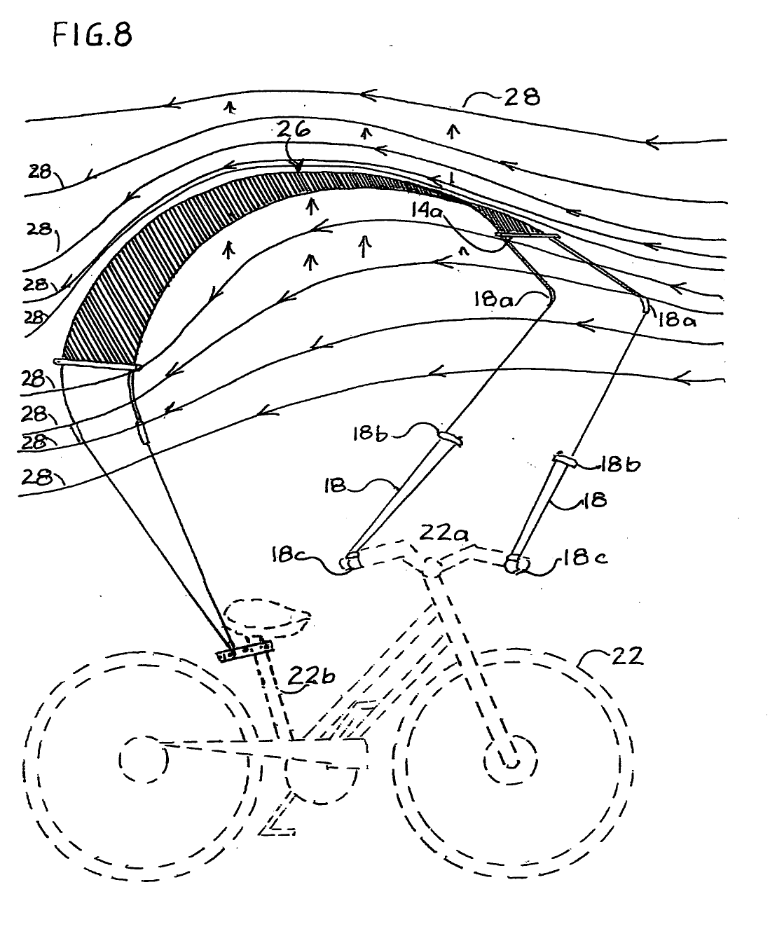

In the foregoing descriptions, improvement over previous designs, have to do with the aerodynamic function of the wing camber FIG. 8 and the lift it creates when the angle of attack of the leading edge wing tube 14a, is adjusted by the wing control cables 18 to increase or decrease lift.

The relationship between wing lift FIG. 8 and less human effort to propel a bicycle or tricycle, is that it allows for lighter components of the wing ribs 12a, hence less overall weight of the bicycle or tricycle. The second factor of the aerodynamic wing is less drag (wind resistance). Less overall weight and less wind resistance reduce the human effort necessary to propel the bicycle or tricycle.

The foregoing have described advantages of the present invention, but it should be understood that when riding a bicycle or tricycle having a suspended cover installed over a rider increases weight and drag (wind resistance). This increases the need for human effort to propel a bicycle or tricycle. This applies to all designs, new and old in the art including the present invention Shade Wing. Our claim is not to eliminate weight and wind resistance but to minimize this inefficiency.

The components of the system and the reference numbers in the various figures are as follows:

10 is the overall invention.

12 is the wing frame.

12a are the four ¼ inch by 30 inch round fiberglass flexible wing ribs of the wing frame.

12b are the four ¼ inch interior diameter dimpled steel coupling tubes.

14a is the leading edge of the wing frame, ½ inch outside diameter CPVC.

14b is the trailing edge of the wing frame, ½ inch outside diameter CPVC.

14c are the eight holes drilled in the leading and trailing edges of the CPVC wing tubes.

14d are the four poly endcaps covering the ends of the leading and trailing edge CPVC wing tubes.

16 is the nylon wing cover with sewn pockets.

16a are the four pockets sewn in the nylon wing cover.

18 are wing control cables.

18a are nylon wing frame connection tubes.

18b are nylon cable slide locks.

18c are Velcro straps.

20 are Universal Adapter angleplates.

20a are Universal Adapter backplates.

20b are Universal Adapter extension rods.

22 is the bicycle.

22a is the bicycle handlebars.

22b is the bicycle seat post.

24 is the adult tricycle.

24a is the adult tricycle basket.

24b is the adult tricycle crosstube.

26 is the wing camber (curve of the wing).

28 is the air flow speed and direction lines

What is claimed as being new and desired to be protected by Letters Patent of the United States is as follows:

1. Increased efficiency (less human effort needed to propel a bicycle or tricycle) when the present invention Shade Wing is attached to a bicycle or tricycle. This is as opposed to using any other suspended cover representing the art. The shade wing accomplishes this by using a wing to support the cover. The wing is formed by two main components. The wing frame and the wing cover. The wing frame is a wing leading edge tube and wing trailing edge tube. These tubes have holes drilled at a 5 degree angle to accept the insertion of the two lateral wing ribs which complete the wing frame. The offset 5 degree drilled holes cause the wing ribs to bow outwardly giving increased rigidity to the wing when inserted into the cover. This eliminates a need for a center wing support tube. The second component of the wing is the rectangular nylon cover with four fixed pockets sewn adjacent to each edge. When the wing leading edge tube, trailing edge tube, and the wing ribs are inserted into the wing cover pockets, the wing ribs are in compression within the pockets, increasing wing rigidity. The wing creates lift which assists the flexible wing ribs to support the wing cover, leading and trailing edges thereof. This allows for the use of lighter wing ribs thus reducing the overall weight of the bicycle or tricycle. The aerodynamic wing also reduces drag (wind resistance). These efficiencies reduce the human effort needed to propel a bicycle or tricycle.

2. a Universal Adapter allowing the shade wing to be installed without modification to any bicycle or tricycle. This shade wing provides protection from the sun and light rain. Previous inventions of this art have been restricted to specific applications or have required additional modifications for instillation of the cover to various applications. The Universal Adapter in the present invention is: (a) two rigid steel straps (angleplate) die cut with holes and pressed with angles to fit the standard seat post of a bicycle (b) two malleable steel straps (backplate). When used with the angleplates form a bracket that is attached to the (c) ¼ inch steel (extension rod). This then is bolted to the angleplate and coupled to the trailing wing rib by ¼ inch coupling tubes. This system allows the shade wing to be attached to any bicycle or tricycle to provide protection from sun and light rain.
